(19) United States
(12) Patent Application Publication
(10) Pub. No.: US 2023/0106385 A1
(43) Pub. Date: Apr. 6, 2023

(54) Innovation Toolkit For Mobile Devices

(71) Applicant: SAP SE, Walldorf (DE)

(72) Inventors: Shweta Roy Chowdhury, Bangalore (IN); Malika Mantri, Bangalore (IN)

(21) Appl. No.: 17/494,527

(22) Filed: Oct. 5, 2021

(51) Int. Cl. G06Q 30/06

(52) U.S. Cl. CPC G06Q 30/0621

(57) ABSTRACT

A mobile model in conjunction with an innovation toolkit allows collaboration through specific triggers to design mobile applications that are more useable and intuitive. The mobile model is organized according to a hierarchy reflecting various considerations (e.g., security, privacy, mobile device capabilities) in order to design usable and intuitive mobile applications for enterprise solutions. Triggers extracted from the mobile model form the basis for cards of the toolkit. Following population of the cards with trigger details (e.g., trigger title, trigger description, data and metadata related to the trigger), the cards can be reviewed and changed by collaborating members of a mobile product team. Brainstorming products (e.g., checklists, images/video, search results providing trigger examples) are thus centrally stored and available to facilitate additional discussion between team members. Particular embodiments may feature triggers extracted from a mobile model having macro-category/theme/functional classification/data point hierarchy levels, to promote Human Resources (HR) activities.

### BACKGROUND

Unless otherwise indicated herein, the approaches described in this section are not prior art to the claims in this application and are not admitted to be prior art by inclusion in this section.

The number of smartphone users worldwide today surpasses 3 billion and is forecasted to further grow by several hundred million in the next few years. While most people use their phones for a range of casual activities, adoption of phones in the workplace has lagged.

There may be various reasons why employees have not embraced using their mobile as a preferred device in the workplace. The reasons range from device capabilities (e.g., limited storage, small screen real-estate) to contextual factors (e.g., a laptop is already a preferred device for complex software used at work).

### SUMMARY

Collaboration of design of software applications that promote adoption of mobile devices in a variety of environments (e.g., the workplace) is accomplished through use of a mobile model in conjunction with an innovation toolkit. The mobile model is organized according to a hierarchy reflecting various considerations (e.g., security, privacy, mobile device capabilities) for a user to adopt their mobile device for employment purposes. Triggers extracted from the mobile model form the basis for cards of the toolkit. Following population of the cards with trigger details (e.g., trigger title, trigger description, data and metadata related to the trigger), the cards can be reviewed and changed by collaborating members of a mobile product team. Brainstorming products (e.g., checklists, images/video, search results providing trigger examples) are thus centrally stored and available to facilitate additional discussion between team members. Particular embodiments may feature triggers extracted from a mobile model having macro-category/theme/functional classification/data point hierarchy levels, to promote Human Resources (HR) activities.

The following detailed description and accompanying drawings provide a better understanding of the nature and advantages of various embodiments.

### BRIEF DESCRIPTION OF THE DRAWINGS

FIG. 1 shows a simplified diagram of a system according to an embodiment.

FIG. 2 shows a simplified flow diagram of a method according to an embodiment.

FIG. 3 shows a simplified view of one example of an innovation platform according to an exemplary embodiment.

FIGS. 4-6C shows details of a portion of the mobile model of FIG. 3.

FIG. 7 shows a simplified view of an exemplary user interface screen for the innovation platform of FIG. 3.

FIG. 8 illustrates hardware of a special purpose computing machine configured to implement collaboration to promote mobile device usage according to an embodiment.

FIG. 9 illustrates an example computer system.

### DETAILED DESCRIPTION

Described herein are methods and apparatuses that implement collaboration to promote mobile device usage. In the following description, for purposes of explanation, numerous examples and specific details are set forth in order to provide a thorough understanding of embodiments according to the present invention. It will be evident, however, to one skilled in the art that embodiments as defined by the claims may include some or all of the features in these examples alone or in combination with other features described below, and may further include modifications and equivalents of the features and concepts described herein.

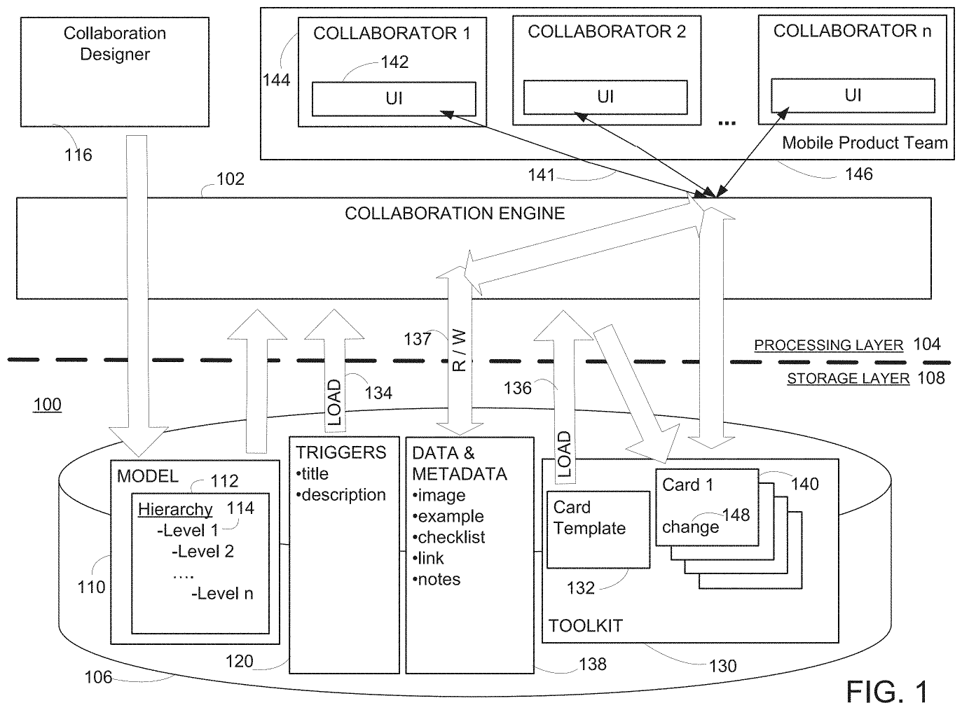

FIG. 1 shows a simplified view of an example system that is configured to implement collaboration for mobile device design according to an embodiment. Specifically, system 100 comprises a collaboration engine 102 that is present in a processing layer 104.

The collaboration engine is in communication with a non-transitory computer readable storage medium 106 such as a database, that is present in a storage layer 108. In particular, the non-transitory computer readable storage medium is configured to store a model 110 representing usage of mobile devices. As described in detail below in connection with the example, the model is developed by a collaboration designer 116 to reflect various considerations on how to make enterprise applications, (especially in the space of Human Capital Management) more usable.

The model includes a hierarchy 112 comprising multiple levels 114. The model is organized into a hierarchy of attributes, functions, behaviors and features. By traversing down through this hierarchy to lower and lower levels, the lowest level of the hierarchy is reached. The lowest level of the hierarchy is a set of triggers which are used to collect data on certain aspects of the mobile application.

As described below, a variety of different triggers 120 have been extracted from the mobile model. A trigger is a lowest level in the model hierarchy upon which data is provided in a collaborative setting to receive input. These triggers, which include a title 122 and a corresponding description 124, are also stored in the non-transitory computer readable storage medium.

An innovation toolkit 130 is also present in the storage layer. This toolkit comprises a card template 132 having specific fields for storing data and metadata relevant to a trigger. As an example, a card template is a data structure for collecting data on aspects of a mobile application. While there are many different aspects of a mobile application that can be used to collect and output data, all such aspects are displayed in a similar format—the card template—in order to assist the users in having a common format for analyzing these aspects.

In particular, in operation the collaboration engine loads 134 the triggers and loads 136 the card template. The collaboration engine further reads and writes 137 data and metadata 138 relevant to collaboration on the triggers. Such data and metadata can comprise, e.g., still images, video, examples, checklists, links, and notes.

Based upon the loaded triggers and template, and data and metadata that is read, the collaboration engine generates a card 140 for each trigger. Fields of the card are populated with information relevant to the trigger (e.g., title, description, images, and/or others as described below).

The cards are then communicated 141 for display at the user interfaces 142 of collaborators 144 belonging to a mobile product team 146. The collaborators interact with the cards to record materials relevant to brainstorming approaches to enhance adoption of mobile device applications designed for the enterprise. Results of a change 148 to the content of the cards by the collaborators, are written back to the non-transitory computer readable storage medium for later reference.

In this manner, the mobile product development team can easily record the results of collaboration sessions. Such results can involve accessing data and metadata relevant to particular triggers, such as notes, links, videos, still images, and the results of searching for examples.

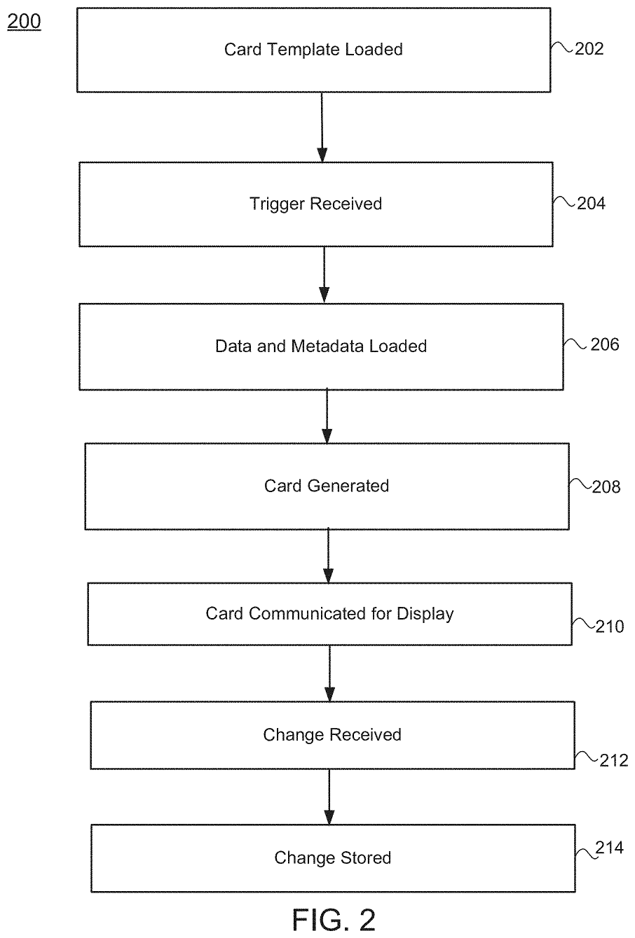

FIG. 2 is a flow diagram of a method 200 according to an embodiment. At 202 a card template is loaded.

At 204 a trigger is received. At 206 data and metadata relevant to the trigger are loaded.

At 208 a card is generated. At 210 the card is communicated.

At 212 a change to the card is received. At 214, the change is stored.

Further details regarding collaboration to promote mobile device usage according to various embodiments, are now provided in connection with the following example.

### EXAMPLE

The system of this exemplary embodiment relates to a framework for performing innovation with the aim to make mobile applications more usable and intuitive, especially for enterprise software and human capital management software. Specifically, mobile devices offer a number of capabilities that can be utilized for building a more synchronous and seamless user experience of mobile applications by leveraging built-in capabilities.

Working with mobile devices can offer challenges such as constrained display area, limited memory and processing resources, and connectivity. However, mobile devices also typically come with valuable built-in capabilities that can include but are not limited to:
location sensing (GPS),
camera,
biometrics,
RFID readers.

In order to promote the utilization of mobile devices in a commercial environment, an exemplary embodiment comprising a mobile model and corresponding innovation toolkit was developed. Coupled together, the model and toolkit allow the implementation of actionable insights in real-time projects. A product design team comprising different stakeholders (e.g., Product Manager, Designer, Researcher Product Design Lead, others) can collaborate using this framework while brainstorming ideas to catalyze innovation in upcoming mobile projects.

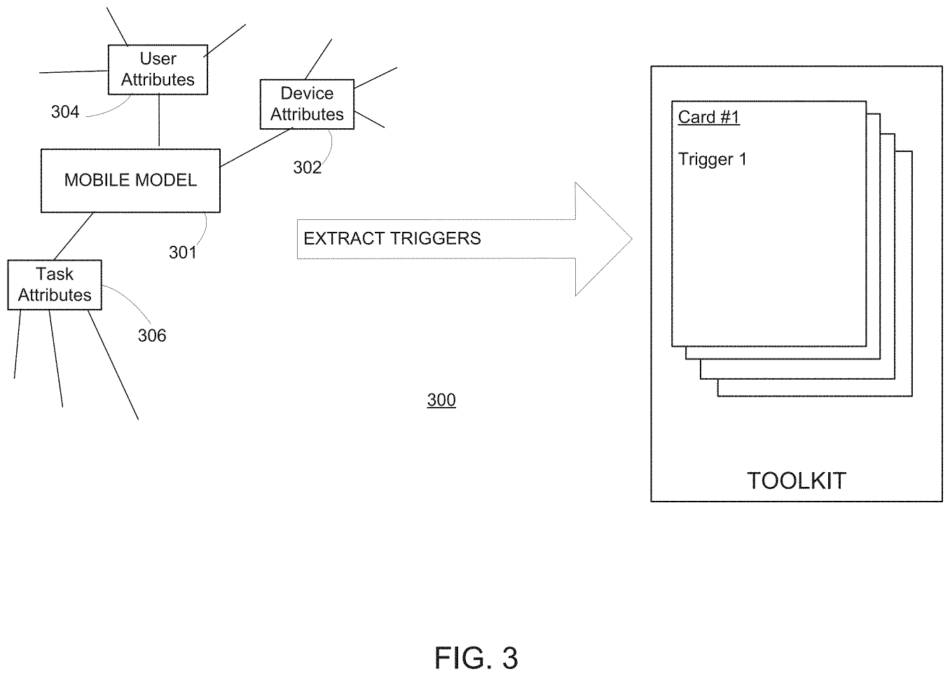

FIG. 3 provides an overview of the process 300. The mobile model 301 is a snapshot of the factors influencing user behavior and their inter dependencies. The model showcases the following three macro-categories that influence the mobile experience:
Device Attributes 302
User Attributes 304
Task Attributes 306

The first macro-category of the mobile model is device attributes. These relate to, e.g., inherent capabilities of device and/or security barriers for organizational use.

Users have reported the tediousness of the process of installing the HR application on a mobile device. These moments of friction shed light on the micro barriers that exist right from procuring a mobile to logging and using it for organizational tasks.

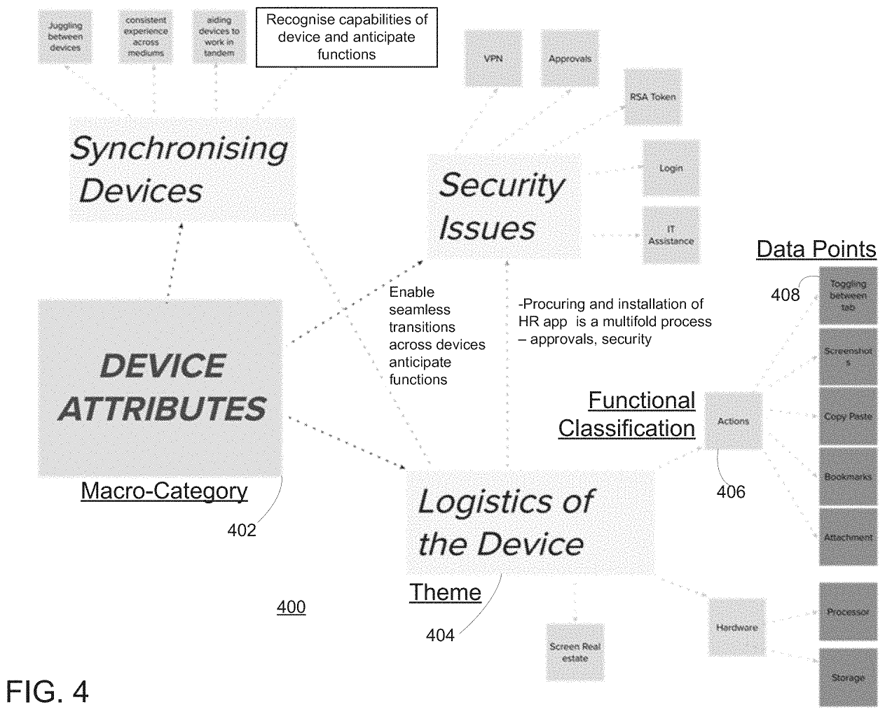

FIG. 4 shows details of the device attribute portion of the mobile model. This figure illustrates the general structure of the mobile model. That is, the mobile model is organized according to the following four-level hierarchy 400:
Macro-category 402
   Theme 404
      Functional Classification 406
         Data Point 408

The second macro-category is user attributes. This relates to how technology acts as an enabler, imparting a sense of privacy towards mobile as a device. The attributes capture the essence of the mobile user—including but not limited to: expectations, motivations, unmet needs, and gaps in experience.

This second macro-category sheds light upon the innate characteristics of users, their values and needs. Users are empowered by tech intelligence when it comes to decision-making From a psychological perspective there are underlying motivations of the users to use mobile like the openness of the organization to let the employees use their mobile in the work environment. There are also some inhibitions for using mobile for HR tasks as mobile is a personal device and there is a sense of privacy attached to it.

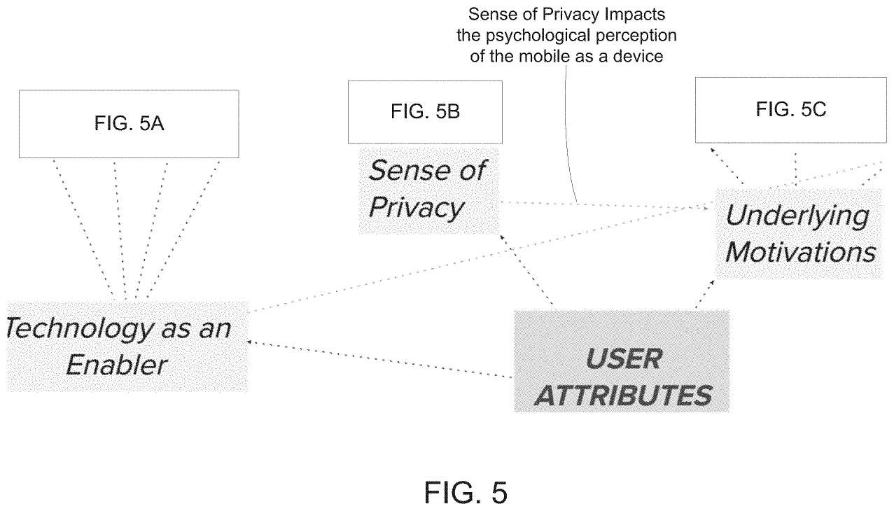

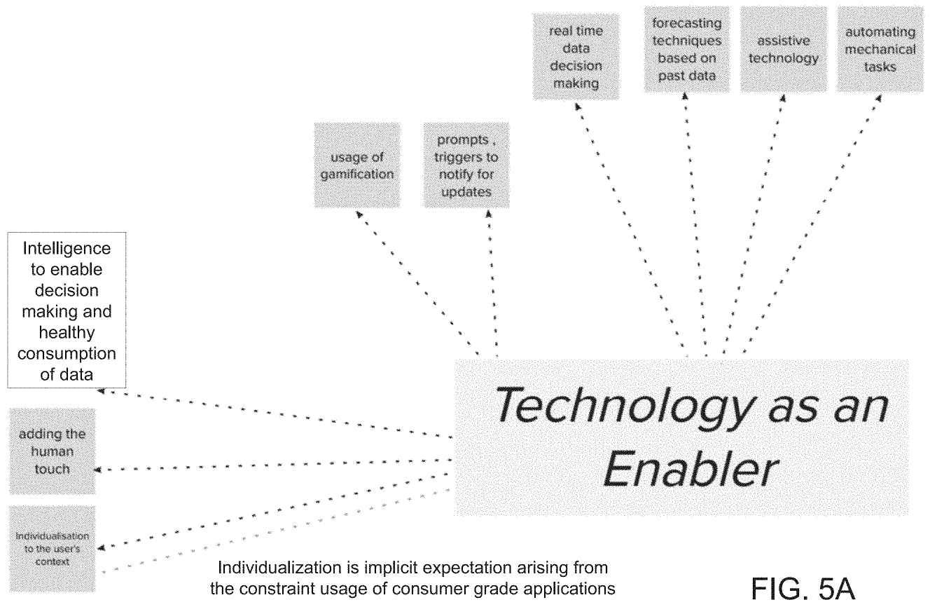

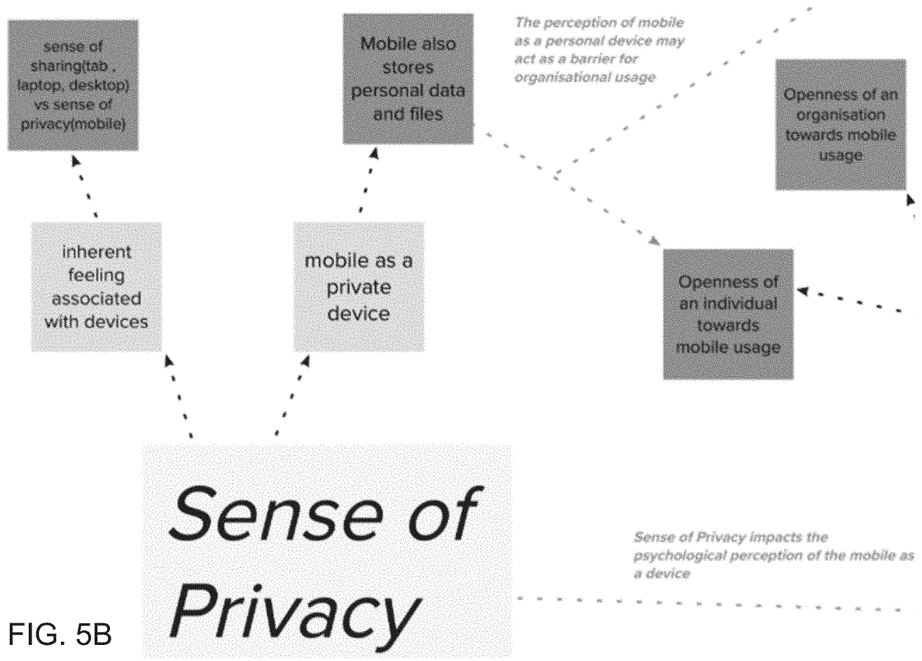

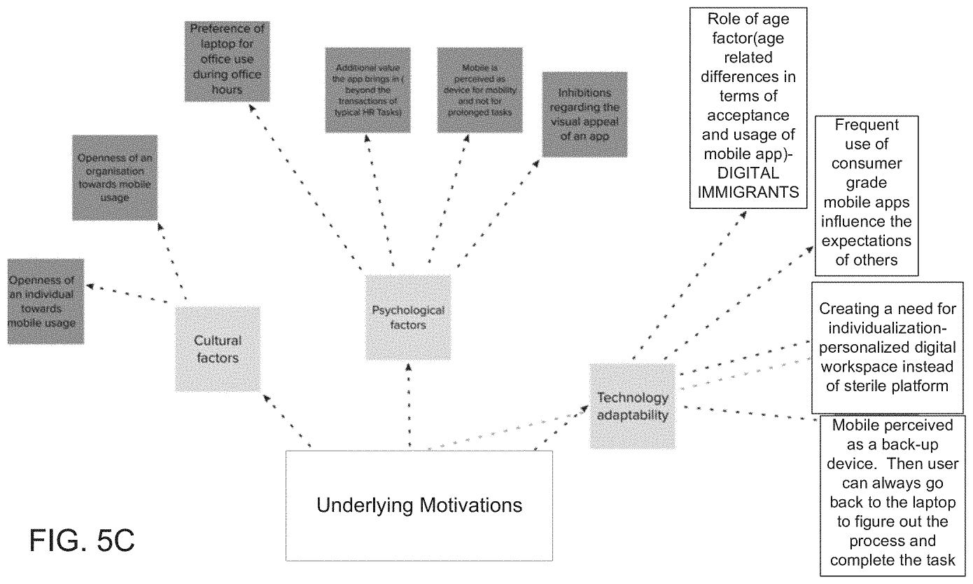

As shown in FIG. 5, the user attribute macro-category comprises the following three main themes:
Technology as an Enabler
Senser of Privacy
Underlying Motivations.
   Details regarding these themes are shown in FIGS. 5A-5C.

The third macro-category of the mobile model is task attributes. These relate to impact of consumer grade applications, and cognitive load associated with tasks.

The task attributes highlight the nature of tasks and how these characteristics themselves impact user experience. Mobile as a device is perceived for mobility hence the nature of tasks expected on it are very different from nature of tasks on a laptop. They are expected to be designed with low cognitive load.

The task attributes highlight the nature of tasks and how their characteristics themselves impact the user experience. In the context of studies conducted, since the focus was specifically on HR tasks, the nature of the tasks impacted the user experience. There were some attributes that were expected from a task flow that was fairly high in cognitive load as is in the case of HR tasks. When the users are guided to the task, it needs to be their one-stop solution to all their HR needs, users seek for similar integrated and digital experience provided on other platforms. Mobile has become their channel of communication and collaboration for employee engagement, hence making HR applications go beyond the radar to just perform HR tasks.

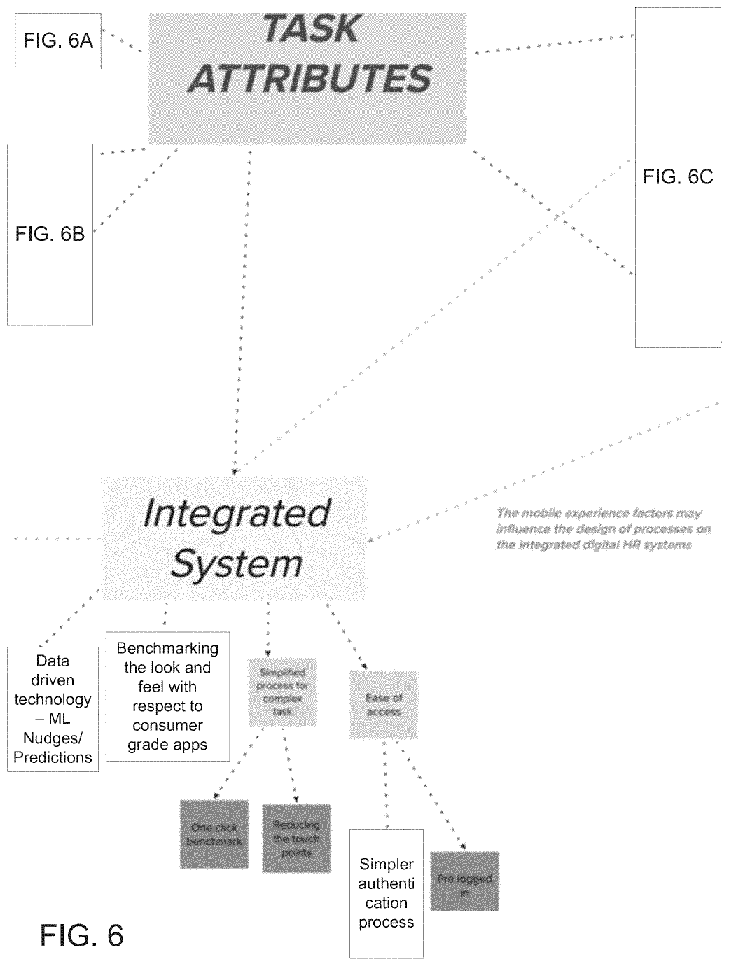

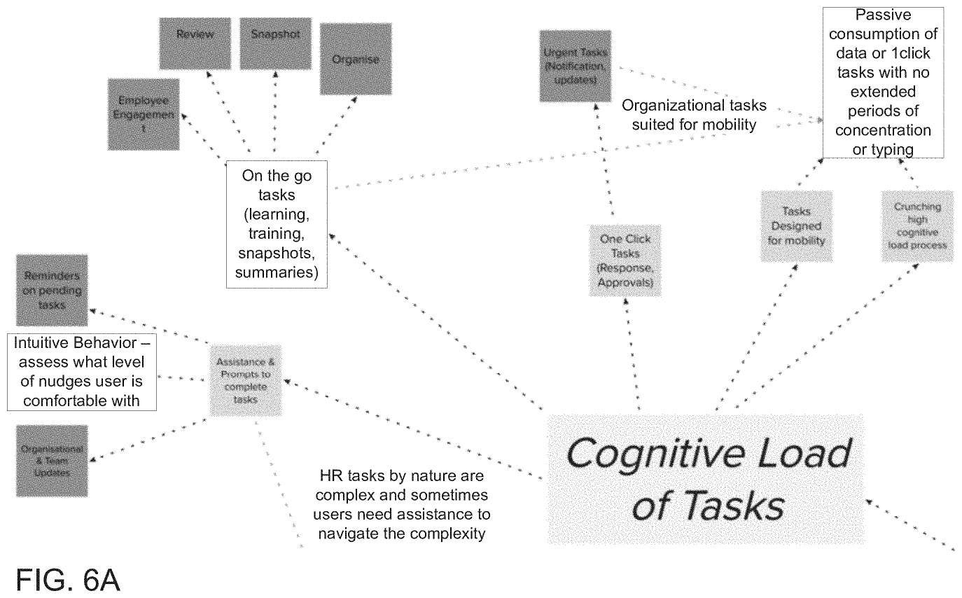

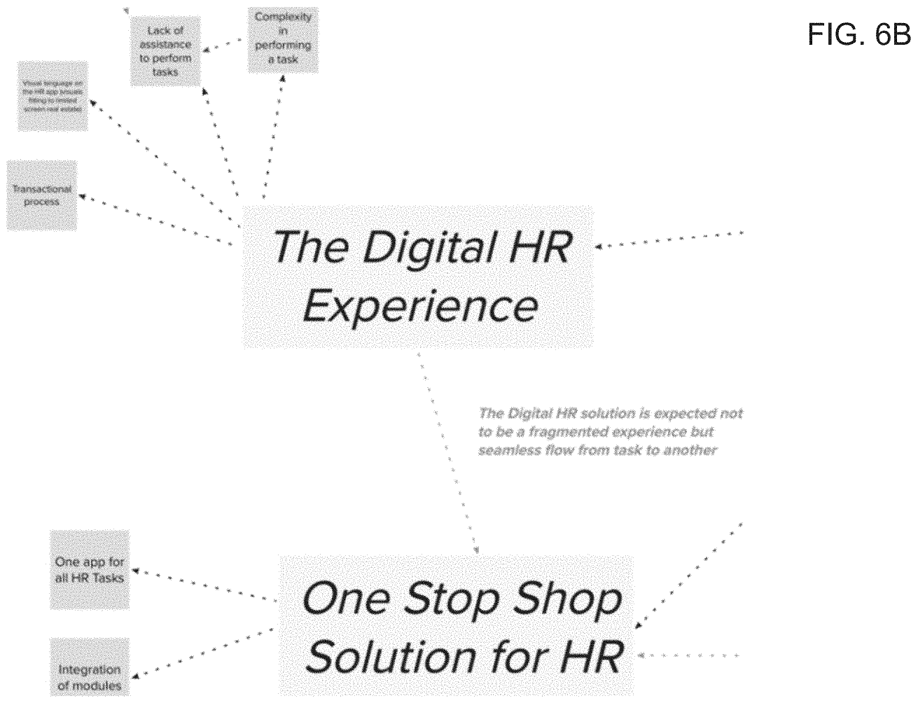

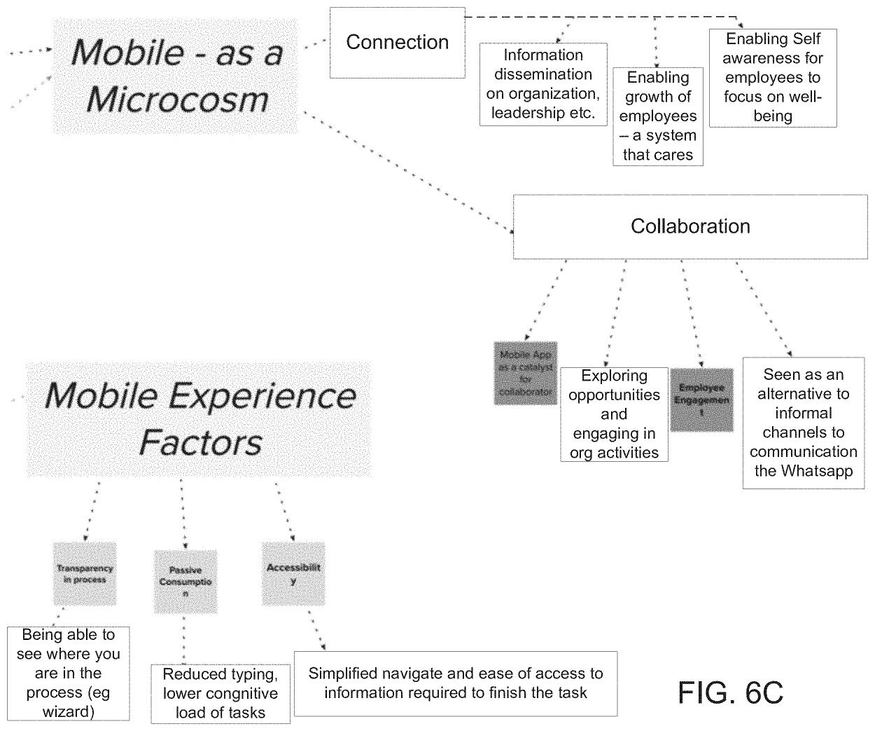

As shown in FIG. 6, the user attribute macro-category comprises the following themes:
Integrated System
Cognitive Load of Tasks
The Digital HR Experience
One Stop Shop Solution for HR
Mobile—as a Microcosm
Mobile Experience Factors
   Details regarding these themes are shown in FIGS. 6-6C.

From specific insights that are derived from the model, the innovation toolkit extracts, assembles, and presents a set of triggers to allow innovation in the mobile product development process. Here, this embodiment recognizes eleven particular triggers.
01. Customer Benefit
02. Task Flow Transparency
03. User Input
04. Cognitive Load
05. 3D Assistive screens
06. Environment Usage
07. Navigation
08. Maximizing Device Capabilities
09. Design for Touch
10. Emotional Experience Touchpoints
11. Synchronize Devices

Customer Benefit. Mobile is often perceived as the go-to device by users to perform quick tasks. Understanding the underlying motivations and identifying needs/triggers become critical. Moreover, there should be clarity around who is the exact customer or who is the ultimate user of the function/feature. Is it a power user, moderate user, or beginner? Sketching out such personas will help understand their particular needs appropriately in the entire product ecosystem. Functions, features, or solutions should not be put in the design without any rationale. It should voice out the customers' needs and add value to the end-users as well as the product. The intention of having this trigger is to realign the product development team's objective with the customer's need or benefit. The discourages jumping into the “how” of product development without having spent enough time on “why”.

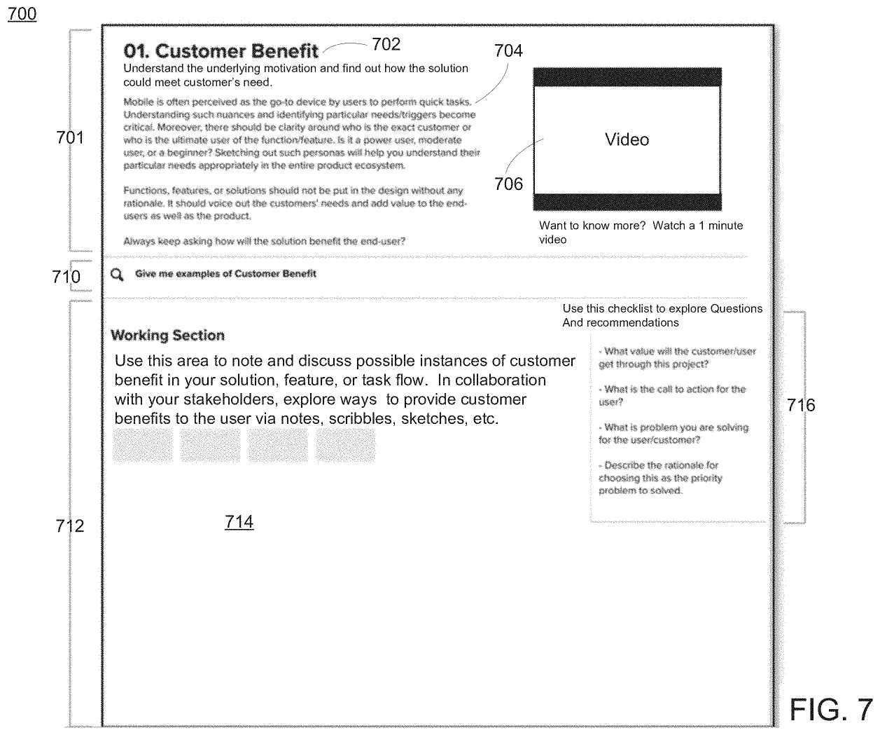

FIG. 7 is a screen shot showing the specific displayed card 700 of the innovation toolkit for the Customer Benefit trigger. The card template format includes a display section 701 that includes a title 702 and a description field 704.

The display section further comprises an image display field 706. That field can display still images or videos that are relevant to collaboration efforts.

The card template further comprises a search area 710. This can allow a user to investigate real-world examples of how different products or services are applying them into their design solutions.

The card template further comprises a working section 712 that includes a brainstorming area 714. A brainstorming area is constructed to jot down ideas the team members come up with. The videos and images are put together for reference and a checklist 716 is placed in case the team hits a roadblock while ideating.

The remaining ten particular triggers recognized by this exemplary embodiment, are now discussed. Each of these would be presented in the toolkit as a corresponding separate card having a template with the same sections as described above for the particular Customer Benefit card.

Cognitive Load. Cognitive Load is the amount of users' attention associated with executing tasks efficiently. The theory places emphasis on human cognitive architecture.

Cognitive load can relate to the quantity, quality, complexity, or relationship between pieces of information. This effect is more pronounced on mobile devices. High cognitive load adversely impacts user's efficiency and satisfaction, resulting in negative effects on task completion. Cognitive load experience is distinct for all users, people using a product/system for the first time may experience a higher cognitive load than experienced or power users.

Let us say the user needs to take any action based on many facets of information. The solution should ask whether the mobile experience handles this cognitive load in a conscious and meaningful way. Put simply, if the user has to ‘juggle too many cognitive balls’ while interacting with the solution, feature or task-flow, it should be re-examined

Design for Touch. This third trigger includes understanding the ergonomics and designing for touch as it put information in the user's hand. Unlike the mouse or keypad, fingers are the most used cursors on the mobile. When designing actionable elements for a mobile interface, it may be important to make targets visible enough so that they are easy for users to tap. Mistaken taps often happen due to small touch controls or fat-finger errors.

That does not imply that the icons should be always bigger. Rather, it is a matter of usability. Understanding the hot spots, the touch targets of the users, the appropriate distance between action buttons, placement of the buttons help in limiting the margin of error that can be caused by the user. The various screen sizes of mobiles and the placement of the call to action in high touch zones need to be considered as well.

Emotional Experience Touchpoints. In today's globalized world, mobile is an ecosystem of solutions and encompasses micro-engagement opportunities with society. People are not just dependent on mobile for these engagements, but are also emotionally attached to the device. While designing there is a need to understand the feelings (highs and lows) the user goes through when they access the product or service.

For example: when there is a payment failure a user might not know where the amount has been lost; or while filling out a form they might attach the wrong files. During such instances how can the design assure the user and provide measures that can alleviate negative conditions? Another aspect to it is that design can be used as a mechanism to uplift the mood of the user during their entire task flow. Adding emotional intelligence, providing individualized experiences, or adding visual distractions can be some of the ways to make the emotional experience better.

Environment of Usage. Mobile has become a ubiquitous device and its usage is increasing. People across different generations are seen using it all day for multiple reasons like texting, listening to music, doing their office work on the go, and much more. It becomes important to consider the circumstances in which the user is accessing the mobile, and the kind of tasks they are trying to accomplish.

For example, if an employee is commuting to the office, what kind of tasks could s/he possibly do, and what technology can be put to leverage? Identifying and mapping these opportunities in the user's journey can help address the user's needs and grab their maximum attention. Learning for example, can be designed for commute by adding more audio content. Understanding the context around the users help design better solutions.

Maximizing Device Capabilities. In today's world, mobiles are not limited to just connecting people, they have capabilities that make them inseparable from the user. Fingerprint sensors are used for seamless logins in apps. NFC (near-field communication) is being used for payments. Haptic touch is replacing 3D touch in smartphones.

It quite interesting how these devices have potential that goes beyond the screen interface. Keeping this in mind, how can we bring these strengths of the device into play and add value to the user experience. Though these devices come with inherent constraints like smaller screen real estate, limited storage capacity, they do provide us with a range of opportunities. Push the thinking beyond “mobile-first” and start thinking about leveraging device capabilities first. For example, in the context of HR tasks, the camera can be put into use to upload the various bills, receipts in the system to get them reimbursed.

Navigation. One of the main reasons cognitive friction occurs is because the users struggle to find information when they navigate their way through the page. While performing tasks, irrespective of the devices used, the users slowly adapt to the workflow and build muscle memory for it. Providing that parity in navigation across devices becomes essential for users at this point of time.

The following elements that can help reduce this friction:

A) understanding the user's thought processes to decode their thought process while they use the application;
B) highlighting the essential information and making it visible for users;
C) bringing hierarchy to the information i.e., do not inundate the users with all the information on the landing page.

Give the users reasons to stay on the page and explore more of your application to know the product or service better. If the user can easily navigate through the page the chances of them abandoning the task is less.

Synchronize Devices. There is a constant need to enable a consistent experience across mediums and aid them to work in tandem. Some percentage of users research on mobile, but switch to desktop to complete a purchase. Some triggers that cause these instances are the limited screen real estate of the mobile to fill the form, constant zoom in/zoom out to find actionable icons or information, attaching multiple documents, and so on. The solution needs to provide that flexibility to switch from one device to another and grant access to the saved data from the previous device to make it a seamless experience for the users. This can especially be beneficial for the tasks that carry a high cognitive load. Some tasks like income task declaration, compensation planning are by nature complex and carry relatively high cognitive load. Drop-offs on mobile should be anticipated and therefore there should be an option for the user to pick up the task on a laptop and not lose their progress.

Task Flow Transparency. In the context of processes, transparency means creating a system in which the users can understand all relevant steps of a complex task easily and efficiently. Providing such an overview about the sequential steps, reduces user's cognitive load and imparts a brief understanding of the duration of the steps. It thus becomes easy to identify the bottlenecks in the entire workflow. There is a sense of accomplishment or success state that a user goes through while completing a task. Providing cues related to task status like approved, in-progress, delayed, delivered can help in achieving that confidence. Providing relevant details for a complex task can inspire the users to complete the task.

User Input. The user input stands for the information that the user needs to feed into the system to accomplish a task. While designing for mobile, the limited screen real estate of the device as well as the nature of the task need to be considered. Understanding such limitations are important while extracting information because the users find it difficult to fill in so many details which would have been otherwise easy on a laptop. Some measures like auto-fill or automating the system to retrieve data from the existing repository or providing forms that are easy to fill could reduce the workload of the user. The mobile applications should thus ask for the bare minimum amount of information to reduce data redundancy and save the users from the hassle of filling in repetitive information.

3D Assistive Screens. The flat-screen of the mobile can be optimized to serve layers of information through them. These 3D assistive screens act as an additional layer that guides the users when they require intelligence about complex or new features, hence guiding the first time user when they get onboarded onto the app. There are times when users do feel a little lost or anxious while using the platform i.e., transferring funds for the first time on a banking app. Moreover, some terminologies can be difficult for them to comprehend as they might be technical.

Anticipating what tasks the users might want to initiate and ensure that the screen can provide step-by-step guidance helps in mitigating the difficulties and making tasks more simple. It would help the users to navigate through the page and understand the new interface elements. To put it simply, there is a need to understand where and when can such overlay could be done on screens to provide the users with cues to make them feel comfortable and assisted.

The extraction of triggers from the mobile model to define the collaboration platform, may be accomplished using a design synthesis procedure. Briefly, the synthesis procedure is used to translate large volumes of raw data into insights. Through data abduction efforts including but not limited to:
data manipulation,
organization,
pruning, and
filtering,
   designers are able to produce information and knowledge.

One or more insights may emerge from the user's congnitive model while using mobile in organizational context. These can include but are not limited to the following.
User's sense of privacy towards mobile, their underlying motivations to use the device and the role of technology affect the users thought process while completing a task.
Mobile as a device is perceived for mobility hence the nature of tasks expected on it are quite different from the nature of tasks on a laptop. They are expected to be designed with a low cognitive load.
Mobile is no longer just a device; it is a microcosm that serves as a means of communication and collaboration.
Consumer-grade applications and the ever-evolving systems influence the experience of HR applications that are already available to the users. Users therefore, seek the same level of personalization, intuitive interaction, engagement and ease of access from the HR app.
Synchronization between different devices like mobile and laptop, security issues while logging in the application, and logistics of the device like screen real estate, storage or processor are some of the major themes that affect the user's congnitive model.

Returning now to FIG. 1, there the particular embodiment is depicted with the engine responsible for collaboration to make mobile applications more usable and intuitive, as being located outside of the database. However, this is not required.

Rather, alternative embodiments could leverage the processing power of an in-memory database engine (e.g., the in-memory database engine of the HANA in-memory database available from SAP SE), in order to perform various functions such as generating the card from the card template. Also, such an in-memory database could be utilized to store the mobile model from which the triggers are extracted.

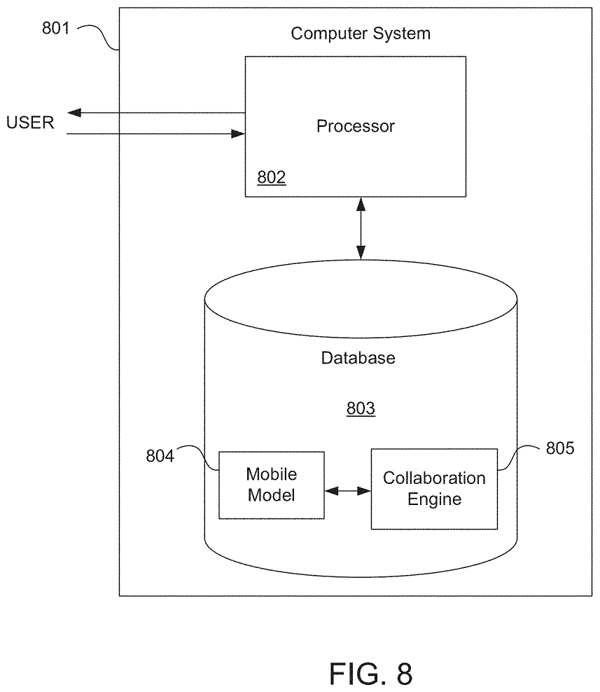

Thus FIG. 8 illustrates hardware of a special purpose computing machine configured to implement table reproduction according to an embodiment. In particular, computer system 801 comprises a processor 802 that is in electronic communication with a non-transitory computer-readable storage medium comprising a database 803. This computer-readable storage medium has stored thereon code 805 corresponding to a collaboration engine. Code 804 corresponds to a mobile model. Code may be configured to reference data stored in a database of a non-transitory computer-readable storage medium, for example as may be present locally or in a remote database server. Software servers together may form a cluster or logical network of computer systems programmed with software programs that communicate with each other and work together in order to process requests.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1. Computer implemented system and methods comprising:

loading a card template;
receiving a trigger comprising a title and a description;
loading data and metadata relevant to the trigger from a non-transitory computer readable storage medium;
generating a card from the card template having fields populated by the title, the description, the data, and the metadata;
communicating the card for display to a first user;
receiving a change to the card from the first user;
storing the change to the card in the non-transitory computer readable storage medium; and communicating the card with the change for display to a second user.

Example 2. The computer implemented system and method of Example 1 wherein the data comprises an image.

Example 3. The computer implemented system and method of Examples 1 or 2 wherein the metadata comprises a link.

Example 4. The computer implemented system and method of Examples 1, 2, or 3 wherein the data comprises a checklist.

Example 5. The computer implemented system and method of Examples 1, 2, 3, or 4 wherein the trigger is extracted from a mobile device model stored in the non-transitory computer readable storage medium and organized according to a hierarchy comprising a macro-category level, a theme level, a functional classification level, and a data point level.

Example 6. The computer implemented system and method of Example 5 wherein the macro-category level comprises a device attribute level, a user attribute level, and a task attribute level.

Example 7. The computer implemented system and method of Examples 1, 2, 3, 4, 5 or 6 wherein the trigger considers navigation, customer benefit, synchronization, or mobile device capabilities.

Example 8. The computer implemented system and method of Examples 1, 2, 3, 4, 5, 6, or 7 wherein:

the non-transitory computer readable storage medium comprises an in-memory database; and an in-memory database engine of the in-memory database generates the card.

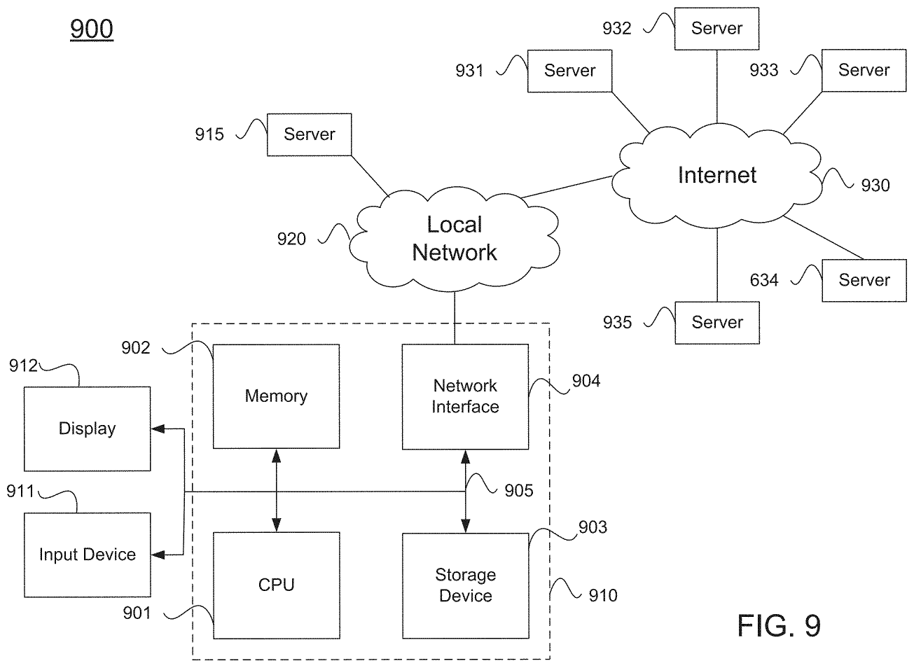

An example computer system 900 is illustrated in FIG. 9. Computer system 910 includes a bus 905 or other communication mechanism for communicating information, and a processor 901 coupled with bus 905 for processing information. Computer system 910 also includes a memory 902 coupled to bus 905 for storing information and instructions to be executed by processor 901, including information and instructions for performing the techniques described above, for example. This memory may also be used for storing variables or other intermediate information during execution of instructions to be executed by processor 901. Possible implementations of this memory may be, but are not limited to, random access memory (RAM), read only memory (ROM), or both. A storage device 903 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 903 may include source code, binary code, or software files for performing the techniques above, for example. Storage device and memory are both examples of computer readable media.

Computer system 910 may be coupled via bus 905 to a display 912, such as a Light Emitting Diode (LED) or liquid crystal display (LCD), for displaying information to a computer user. An input device 911 such as a keyboard and/or mouse is coupled to bus 905 for communicating information and command selections from the user to processor 901. The combination of these components allows the user to communicate with the system. In some systems, bus 905 may be divided into multiple specialized buses.

Computer system 910 also includes a network interface 904 coupled with bus 905. Network interface 904 may provide two-way data communication between computer system 910 and the local network 920. The network interface 904 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 904 sends and receives electrical, electromagnetic, or optical signals that carry digital data streams representing various types of information.

Computer system 910 can send and receive information, including messages or other interface actions, through the network interface 904 across a local network 920, an Intranet, or the Internet 930. For a local network, computer system 910 may communicate with a plurality of other computer machines, such as server 915. Accordingly, computer system 910 and server computer systems represented by server 915 may form a cloud computing network, which may be programmed with processes described herein. In the Internet example, software components or services may reside on multiple different computer systems 910 or servers 931-935 across the network. The processes described above may be implemented on one or more servers, for example. A server 931 may transmit actions or messages from one component, through Internet 930, local network 920, and network interface 904 to a component on computer system 910. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A method comprising:
loading a card template;
receiving a trigger comprising a title and a description;
loading data and metadata relevant to the trigger from a non-transitory computer readable storage medium;
generating a card from the card template having fields populated by the title, the description, the data, and the metadata;
communicating the card for display to a first user;
receiving a change to the card from the first user;
storing the change to the card in the non-transitory computer readable storage medium; and
communicating the card with the change for display to a second user.

2. A method as in claim 1 wherein the data comprises an image.

3. A method as in claim 1 wherein the metadata comprises a link.

4. A method as in claim 1 wherein the trigger considers customer benefit.

5. A method as in claim 1 wherein the trigger considers navigation.

6. A method as in claim 1 wherein the trigger considers mobile device capabilities.

7. A method as in claim 1 wherein the trigger considers synchronization.

8. A method as in claim 1 wherein the trigger is extracted from a mobile device model stored in the non-transitory computer readable storage medium and organized according to a hierarchy comprising a macro-category level, a theme level, a functional classification level, and a data point level.

9. A method as in claim 8 wherein the macro-category level comprises:
a device attribute level;
a user attribute level; and
a task attribute level.

10. A method as in claim 1 wherein:
the non-transitory computer readable storage medium comprises an in-memory database; and
an in-memory database engine of the in-memory database generates the card.

11. A non-transitory computer readable storage medium embodying a computer program for performing a method, said method comprising:
loading a card template including an image display field;
receiving a trigger extracted from a mobile device model, the trigger comprising a title and a description;
loading data and metadata relevant to the trigger from a non-transitory computer readable storage medium, the data comprising an image for display and the metadata comprising a link;
generating a card from the card template having the image display field populated by image data, and other fields populated by the title, the description, and the metadata;
communicating the card for display to a first user;
receiving a change to the card from the first user;
storing the change to the card in the non-transitory computer readable storage medium; and
communicating the card with the change for display to a second user.

12. A non-transitory computer readable storage medium as in claim 11 wherein the metadata comprises a link.

13. A non-transitory computer readable storage medium as in claim 11 wherein the data comprises a checklist.

14. A non-transitory computer readable storage medium as in claim 11 wherein the data comprises an example.

15. A non-transitory computer readable storage medium as in claim 11 wherein the trigger considers customer benefit.

16. A computer system comprising:
one or more processors;
a software program, executable on said computer system, the software program configured to cause an in-memory database engine of an in-memory database to:
load a card template;
receive a trigger comprising a title and a description;
load data and metadata relevant to the trigger from the in-memory database;
generate a card from the card template having fields populated by the title, the description, the data, and the metadata;
communicate the card for display to a first user;
receive a change to the card from the first user;
store the change to the card in the in-memory database; and
communicate the card with the change for display to a second user.

17. A computer system as in claim 16 wherein the data comprises an image.

18. A computer system as in claim 16 wherein metadata comprises a link.

19. A computer system as in claim 16 wherein the trigger is extracted from a mobile device model stored in the in-memory database and organized according to a hierarchy comprising a macro-category level, a theme level, a functional classification level, and a data point level.

20. A computer system as in claim 16 wherein the trigger considers one of:
customer benefit;
synchronization;
mobile device capabilities; and
navigation.
